(19) United States
(12) Patent Application Publication
(10) Pub. No.: US 2005/0128547 A1
(43) Pub. Date: Jun. 16, 2005

(54) Production of a complete image by scanning partial areas of a pattern

(76) Inventor: Markus Simon, Buckenhof (DE)

Correspondence Address: BELL, BOYD & LLOYD, LLC, P. O. BOX 1135, CHICAGO, IL, 60690-1135, US

(21) Appl. No.: 10/510,618

(22) PCT Filed: Apr. 23, 2003
(86) PCT No.: PCT/EP03/04228

(30) Foreign Application Priority Data
Apr. 23, 2002 (EP) 02009056.9

(51) Int. Cl. G02B 26/08

(52) U.S. Cl. 359/202

(57) ABSTRACT

The present disclosure relates to a method for producing a resulting image from a plurality of individual images. The method includes producing a plurality of individual images using a scanning movement, and offsetting the individual images in relation to each other. The method further includes obtaining image information from the individual images according to the offsetting, and producing the resulting image using the obtained image information.

### BACKGROUND

The present disclosure relates to a method for producing a resulting image from a plurality of individual images.

Such a method can, for example, be used to obtain a panoramic image, or to scan documents.

The solid angle given by a camera and objective, that is scanned or recorded by an image, is in many situations inadequate for completely recording objects from the surroundings. In particular, the use of wide-angle objectives to completely record objects is not always possible, or always desired. Because of the characteristics of lenses, a very wide-angle objective causes extreme distortions at the edges of the image that interfere considerably with the impression. Furthermore, the quality of the display of the object is disturbed by the limited sensor resolution. In addition, in many cases, replacement of the lens or of the objective is not possible, because the component is firmly integrated into the camera.

Many previous methods have attempted to deal with a similar subject related to the generation of panoramic images, correcting the sensor defect. However, the known previous methods for generating images of a larger field of vision require very expensive and complex arithmetical operations that cannot be performed in real time video to correct the lens and image distortion. For this reason, a calculation of an image with an extended field of vision can generally only be performed offline.

The images used to generate the resulting image of the previous methods only require a slight overlap in the individual images. In those cases, two adjacent images or two consecutive images contain only a little common image information. Furthermore, depending on the environment, the images may contain quite different lighting conditions. Therefore, as a result of an aperture control on the camera, there will exist extremely varied illuminations at the spliced edges of the resulting image, that can likewise only be harmonized at a very great cost.

Fax equipment and flatbed scanners enable the electronic transmission of documents which are available on paper. In many situations this type of equipment is not available, for example, during a meeting. An alternative to the use of a fax machine or a flatbed scanner is such a situation is a digital camera, with which the image information can be saved in digital form. However, the resolution of standard commercial cameras is not yet sufficient to produce adequate resolution for a document in a single exposure.

The scanning of documents by means of many individual images close up to the document to increase the resolution is a known approach. Until now, however, there have only been a few, in part, very unstable methods that can be used to compose a two-dimensional complete image from the individually recorded images.

Most of these methods are based on the image information first being distorted at an initial processing stage by highly complex arithmetical operations. Then, at a subsequent processing stage, the adjacent image information is harmonized with the adjacent images in all four edge directions. Each image is corrected both horizontally and vertically in relation to the adjacent images. The images, therefore, only require a slight overlap to accomplish this. Besides the scarcely tolerable high calculation time, these methods frequently lead to rhombic distortion of the image information which distracts the observer greatly, as shown, for example, in FIG. 1. On account of their complexity, the known methods can generally only be performed interactively, and offline.

### SUMMARY

The present disclosure relates to a method for providing a high-quality resulting image from a plurality of individual images, without a great amount of calculation.

An example of the method for producing a resulting image from a plurality of individual images according to the present disclosure comprises producing the plurality of individual images using a scanning movement, offsetting the individual images in relation to each other, obtaining image information from the individual images as a function of the offsetting, and producing the resulting image using the obtained image information..

Some benefits of the method according to the present disclosure include the rapid processing of the images to produce a resulting image, elimination of the need to correct the lens errors or mapping errors in the image utilizing intensive calculations, elimination of the need to harmonize the illumination at the spliced edges, and controlling the image information as a function of the offsetting.

### BRIEF DESCRIPTION OF THE DRAWINGS

FIG. 1 shows an example of a resulting image prepared from individual exposures according to the prior art.

FIG. 2 shows an example of a resulting image generated by scanning the surroundings.

FIG. 3 illustrates an example of a scanning movement for scanning a document.

FIG. 4 illustrates an example of the image recorded during the scanning movement according to FIG. 2.

FIG. 5 illustrates an example of the result of successive one-dimensional scans.

FIG. 6 illustrates an example of the resulting image according to the present disclosure.

### DETAILED DESCRIPTION OF THE PRESENT EXAMPLES

The method according to the present disclosure is based on the production of individual images which are generated during a one- or two-dimensional scanning movement.

According to the present disclosure individual images are generated which overlap each other to a high degree. This produces a resulting image with almost no distortions that covers a very large solid angle. This also makes it possible, for example, to produce panoramic images or to scan in documents with a very high resolution.

In doing so, the image sensor operates, for example, at full scanning frequency, so that by slowly swiveling across the object to be recorded, adjacent images are only slightly offset against each other. From each image, a part of the undistorted image information is copied from the center of the image into a resulting image. The size of the copied portion detail is controlled as a function of the calculated offset to the previous image. As two adjacent images overlap to a very high degree, the images have almost identical lighting conditions so that when adjacent edges are put together, as a rule no harmonization of the illumination is necessary.

An embodiment of the method according to the present disclosure could, for example, be used with a mobile telephone having a camera module for recording images from the surroundings, a processor for processing image data and for generating the resulting image (i.e., estimate of movement, image composition, etc.), and a display for displaying the resulting image.

An example of generating the resulting image as shown in, for example, FIG. 2, on the basis of an image sequence, includes processing the estimation of movement of two adjacent images, as well as the structure of the resulting image.

The above methods are explained in more detail herein with the assumption, for illustrative purposes only, that the scan follows the surroundings one-dimensionally from right to left.

Regarding the estimation of movement of two adjacent images, the movement is determined, for example, according to a MSE (Mean Squared Error) method. In the MSE method, the best possible match in a local neighborhood to the previous image is sought for an image area of the initial image. The best match provides the displacement vector of the two images relative to each other.

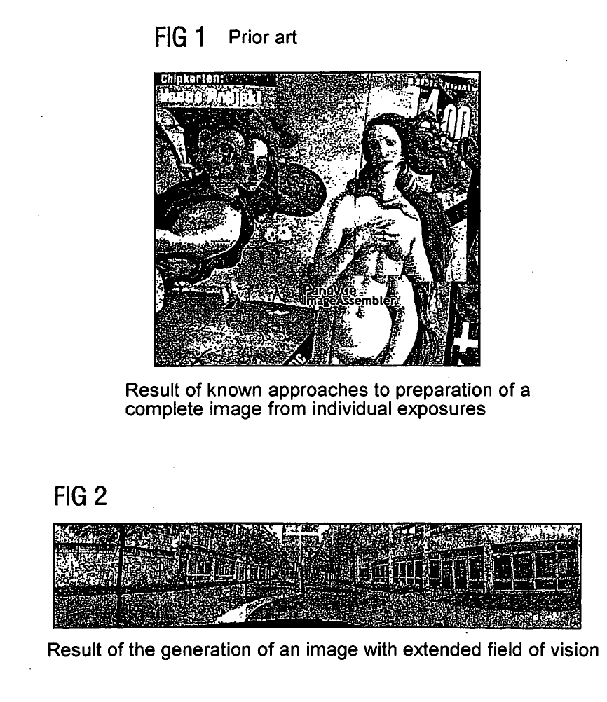

Regarding the structuring of the resulting image, using the displacement vector, the position inside the resulting image to which the additional image information is copied is ascertained. The width of the copied portion detail of the initial image is provided by the offset of the images in the direction of scanning, for this example in the horizontal direction from right to left (i.e., direction x). In this way no gap arises between the copied portion detail already put together and the added copied portion detail. Perpendicular to the direction of scanning (i.e., direction y), the complete image information is taken into account. The result of the processing of many images according to this method can be seen, for example, in FIG. 1.

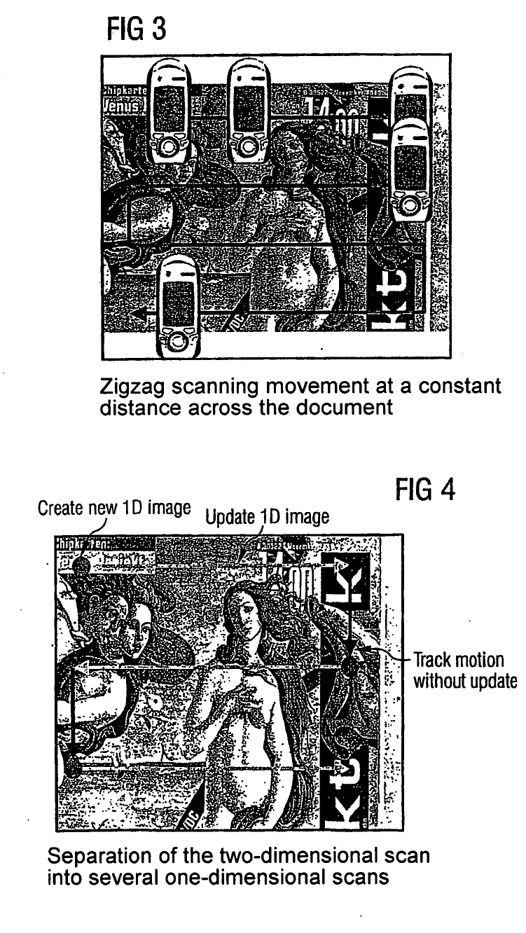

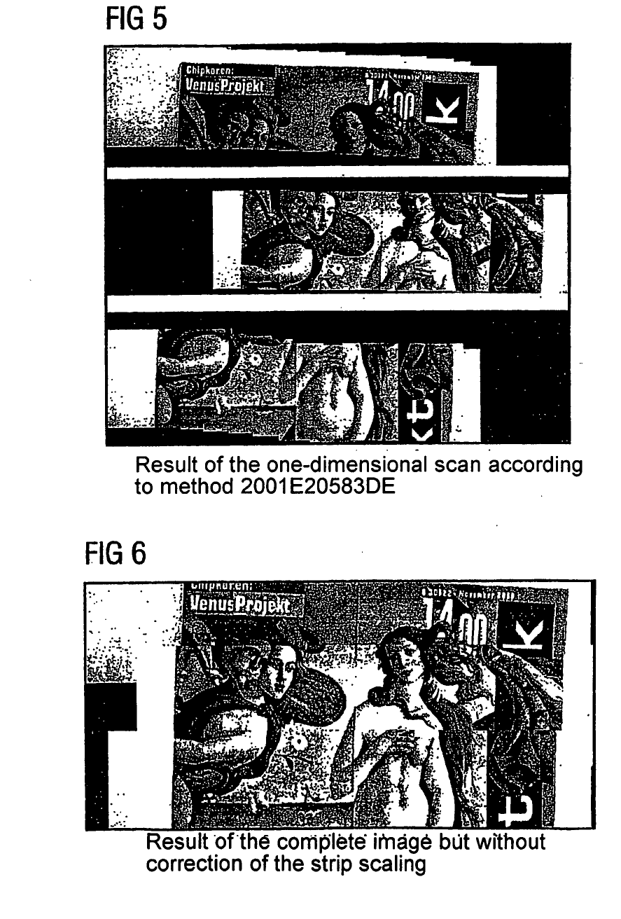

According to the present disclosure, scanning of the document takes place by means of a zigzag movement of the camera across the document at a constant distance, as shown in, for example, FIG. 3. In order to avoid variations in the distance to the document and consequently changes in the size of the images during the scanning process, for example, the camera is guided across the document on a frame with the camera pointing downwards towards the document to be scanned. By analyzing the movement of consecutive images, the two-dimensional scan is separated into several one-dimensional (i.e., horizontal) scans as shown, for example, in FIGS. 4 and 5. Each one-dimensional scan shows a horizontal, undistorted strip of the original document. By separating the two-dimensional scan into several one-dimensional scans, the document generation task is reduced to horizontal scaling of the image strips, and the putting together of the horizontal strips in a vertical direction, as shown, for example, in FIG. 5. By linearly scaling all of the image information, rhombic distortions are avoided in the complete resulting image, as occurs in traditional previous methods, as shown in, for example, FIG. 6.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. Method for obtaining a result image using a plurality of individual images which can be successively produced during a scanning movement, characterized in that the successive individual images are slightly offset in relation to each other, and image information is obtained from the individual images as a function of the misalignment and copied into the result image.

2. Method according to claim 1, characterized in that the scanning movement is two-dimensional in its execution.
